(19) United States
(12) Patent Application Publication
(10) Pub. No.: US 2008/0279074 A1
(43) Pub. Date: Nov. 13, 2008

(54) RECORD CARRIER, DEVICE AND METHOD FOR QUALITATIVE AND RECORD CARRIER INDEPENDENT HIGH SPEED DATA RECORDING

(75) Inventor: Hubert C.F. Martens, Eindhoven (NL)

Correspondence Address: Muncy, Geissler, Olds & Lowe, PLLC, P.O. BOX 1364, FAIRFAX, VA, 22038-1364, US

(73) Assignee: MOSER BAER INDIA LTD., New Delhi (IN)

(21) Appl. No.: 12/040,845

(22) Filed: Feb. 29, 2008

Related U.S. Application Data
(63) Continuation of application No. PCT/IB2006/052959, filed on Aug. 25, 2006.

(30) Foreign Application Priority Data
Sep. 2, 2005 (EP) 05108069.5

(51) Int. Cl. G11B 7/00

(52) U.S. Cl. 369/59.11; 369/275.3

(57) ABSTRACT

A record carrier 21, a recording method and a recording device are provided for qualitative and record carrier independent high speed data recording. The record carrier 21, such as an optical record carrier, comprises at least one information area 210 with at least one reference 2100 to a class 22 of write strategy providing a direction instruction to optimize recording process. The recording method represents an intelligent write strategy optimization method seeking after a suitable write strategy for the record carrier by use of the reference 2100 to a class 22 of write strategy as a backup information on beforehand and by use of details on the recording device being operative for executing the recording method. Coupling of the information about the recording device and the record carrier increases the quality of written data, and the recording method optimizing the write strategy becomes considerably faster when information about the record carrier is known on beforehand. Additionally the recording device becomes able to handle broader classes of record carrier types than what is currently possible by sticking to record carrier with predefined strategy parameters. Additionally a method for manufacturing the record carrier described above is provided.

This application is a Continuation of co-pending International Application No. PCT/IB2006/052959, filed on Aug. 25, 2006, and for which priority is claimed under 35 U.S.C. § 120; and this application claims priority of Application No. 05108069.5 filed in the European Patent Office on Sep. 2, 2005 under 35 U.S.C. § 119; the entire contents of all of which are hereby incorporated by reference.

### DESCRIPTION

The present invention relates to a record carrier, such as an optical record carrier, a recording method, and appropriate recording device, and a method for manufacturing said record carrier. More particularly, record carrier providing information comprising a record carrier related information providing support of said recording method used by the recording device are the objects the present invention comprises.

Continuous development of new optical record carriers (dual/multi layer, high speed, high density, combinations thereof, etc) puts ever stronger constraints on the accuracy and complexity of the so called write strategies that define the way in which a recording device writes the user data on record carrier. For optical record carriers write strategy provides a definition of the sequence of pulse trains used for recording means. For instance, new 8× DVD+RW optical record carriers require so called 2T strategies where a write pulse is to be given approximately every second bit-clock cycle and with separate definition for pulse trains used for even and odd mark lengths, dual layer DVD+R DL optical record carriers require strategies with up to 3 pre-heat compensation parameters that depend on the length of the preceding space, and high speed DVD+R optical record carriers require so called castle strategies that fine tune modulation of the longer mark lengths by reducing the power in the middle of the waveform for recording and that fine tune asymmetry by giving power boosts to the shortest mark lengths. For optimization of recording quality, write strategies with history and/or future dependent compensations have been proposed. In such cases information of the previous/subsequent mark is used to determine the optimum pulse shape for recording a current mark. The quality of the recorded data on an optical record carrier is critically dependent on the spot shape and the precise timing and powers. As a result, recording-device-to-recording-device variation (rise/fall times, bias levels, details of optical pickup unit (OPU), etc.) can for nominally identical write strategies yield different recording results. The same arguments hold for record-carrier-to-record-carrier variations, as small variations in e.g. recording stack layout (layer thickness, material compositions, etc) can yield different recording properties than for the nominal optical record carrier. Consequently, details of the write strategy are dependent on both the record carrier type and the details of the recording device. Currently, the write strategy for optical record carriers is specified in the record carrier information. For example for DVD+R or DVD+RW the write strategy is specified in the address in pre-groove field (ADIP) of the corresponding optical record carrier. The endeavour for high density and/or high speed data recording, while maintaining excellent quality of the recorded data, makes the recording performance even more critically dependent on the detailed physical properties of record carriers and recording devices since the physical limits are being reached. Since it is inescapable that small variations in physical parameters of the record carrier and recording device occur during the manufacturing, the idea that a fixed write strategy definition may be used to obtain optimum recording performance becomes invalid.

It is an object of the present invention to provide a record carrier, recording device and a recording method, which allow record carrier independent good quality high-speed and/or high-density recording.

This object is achieved by providing a record carrier according to claim 1. Furthermore, the above object is achieved by a method of recording information according to claim 4, a recording device according to claim 7, and a method of manufacturing said record carrier according to claim 8.

Said record carrier is designed in such a way that it comprises at least one information area comprising at least one reference to a class of write strategy. This class of write strategy provides a direction instruction to optimize the recording process.

The recording method represents an intelligent write strategy optimization method comprising steps of
reading of said reference to a class of write strategy,
performing write strategy optimization by use of said reference to a class of write strategy, wherein a suitable write strategy for said record carrier is sought by use of said reference to a class of write strategy as an additional information about said record carrier on beforehand, and is used by said recording device.

By leaving the seeking after an optimal strategy for recording on the recording device and/or the recording method instead of use of an fixed write strategy and by using the rough information about a write strategy represented by said reference to write strategy class on said record carrier only as direction-wise information, which serves as a support of the method, both essential information resources for recording means can be used, details of an individual recording device and details on an individual record carrier. In this way the quality of the written data is substantially increased. The recording method performing seeking after an optimal write strategy becomes considerably faster when information about the record carrier is known on beforehand. This information is represented in said reference to a write strategy class, this class of write strategy being more an abstract direction instruction and providing just a gross shape of a write strategy. Later, after the optimization step, said class will be replaced by a concrete write strategy determined by the said recording method.

A further advantage of the method is that recording drives will be able to handle broader classes of record carrier types than what is currently possible by sticking to record carrier with predefined strategy parameters. This is an additional result when a recording method attaches great importance to combining details on an individual recording device and an individual record carrier.

Further developments of the invention are defined in the dependent claims.

The present invention will be more clearly understood from the following description of the preferred embodiments of the invention read in conjunction with the attached drawings, in which:

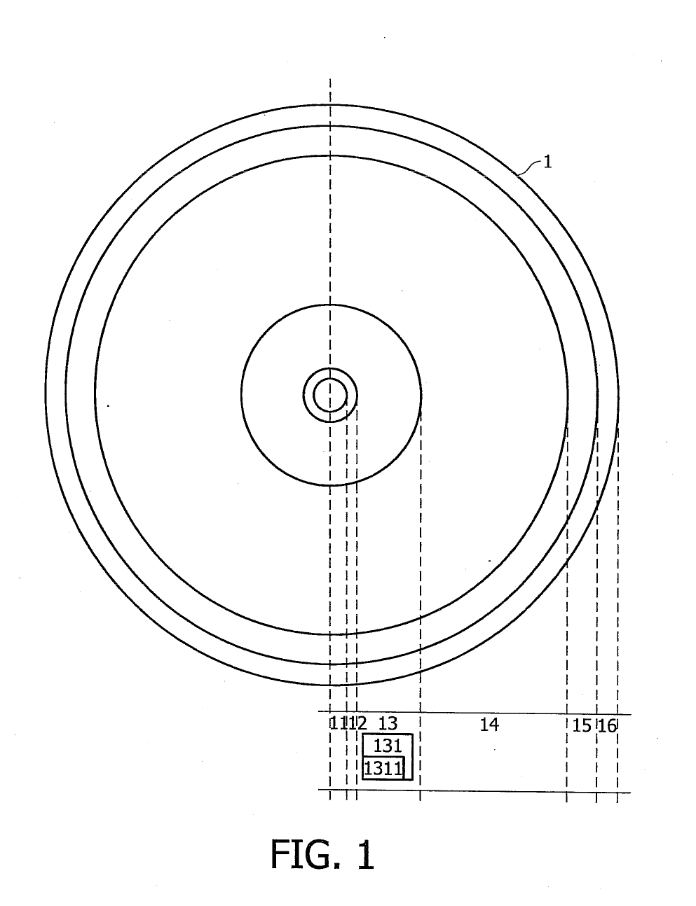

FIG. 1 presents a design of a conventional optical record carrier with an information field containing complete write strategy definition;

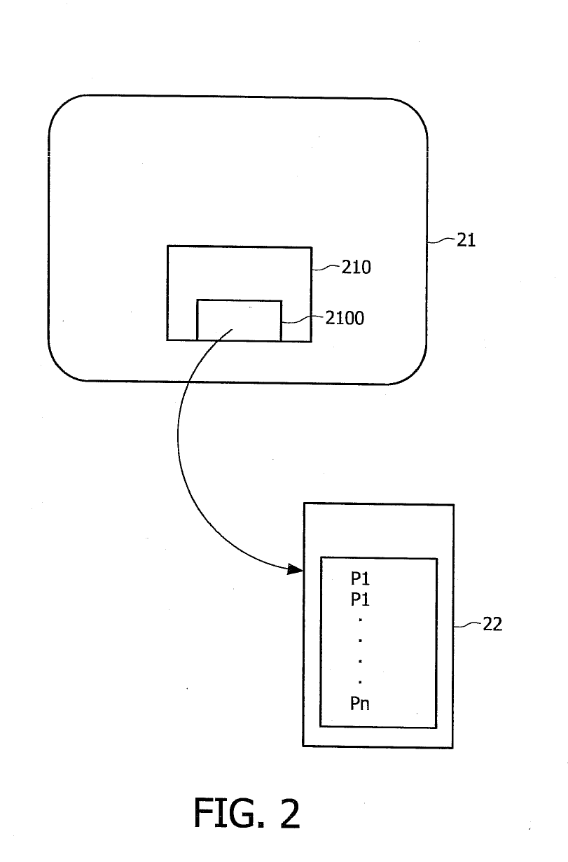

FIG. 2 presents design of a record carrier according to present invention;

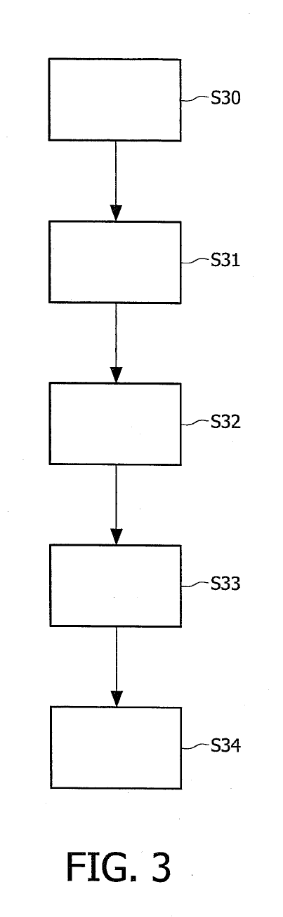

FIG. 3 shows a flow chart of a recording method for recording data on a record carrier according to present invention.

The preferred embodiment will now be described based on the structure of an optical record carrier as shown in FIG. 1.

According to FIG. 1, a conventional optical record carrier 1 comprises several function-ally defined areas:
central hull 11 represents a hull of an optical record carrier serviceable for physical holding and rotating purposes;
inner drive area 12 meant for optical record carrier testing;
lead in area 13 contains optical record carrier specific control information;
data area 14 used for recording user data;
lead out area 15 allowing a smooth lead out and also containing record carrier specific control information;
outer drive area 16 meant for optical record carrier testing like inner drive area 12.

Examples of such a conventional optical record carrier are the CD-R and CD-RW, and writable versions of DVD, such as DVD+RW. The information area (e.g. ADIP if record carrier is a DVD, ATIP if record carrier is a CD, look up table etc.) 131 is located in the lead in area 13 and contains details on at least one write strategy 1311 defining the way in which an optical recording device writes the data on the optical record carrier 1. It is essentially a definition of the laser output waveform during the recording of pits on the record carrier. This write strategy 1311 may comprise history and/or future dependent compensations and is used by a conventional recording method writing data on the record carrier 1. In such a recording process just the record carrier specific information is used.

FIG. 2 presents design of a record carrier 21 according to present invention allowing a record carrier independent good quality high-speed recording, wherein during the recording process details of an individual recording device in combination with the individual record carrier 21 are used to achieve the above mentioned object. The record carrier 21 comprises at least one area 210 in which record carrier related information and at least one reference 2100 to a class of write strategy are stored. The reference 2100 to a class of write strategy refers to a concrete class of write strategy 22. The corresponding relation is represented through the directed and dashed arrow from the reference 2100 to the write strategy class 22. The write strategy class comprises parameters P1, P2, . . . , Pn wherein n>1 constituting the write strategy 22. Parameters P1, P2, . . . , Pn have a support function in the recording method seeking after an optimal write strategy. In case of an optical record carrier these parameters may provide information about waveform format, pulse repetition rate, pulse-train length, history-compensation depth, future-compensation depth, short-mark power boost or start and/of stop of mark power boost etc. It is to be noted that the write strategy class 22 gives just a gross shape for the recording process. Considering the information area comprising said reference 210, in case of an optical record carrier this information area 20 could be for example ADIP, ATIP or a look up table. In addition, also other areas evident to a skilled person for storing information to the reference to a class of write strategy can be used.

The development of the recording method for recording data on a record carrier according to present invention is presented in FIG. 3, which shows a flow chart with some main steps of a recording method for recording data on a record carrier according to present invention. As mentioned above the preferred embodiment is described based on the structure of an optical record carrier. Thus the first step S30 stands for reading of the reference 2100 to a class 22 of a write strategy. By use of the parameters P1, P2, . . . , Pn a write test S31 on the optical record carrier is executed. A play back signal is received from a recorded mark on the record carrier and has to be analyzed by step S32. There a decision will be made whether this signal is acceptable or not. In the case of an acceptable play back signal recording can be started directly by the use of the given class 22 of write strategy. Otherwise an optimization of the write strategy has to be performed. This task is represented by step S33, where an appropriate write strategy by use of the play back signal characteristics, the reference 2100 to the class 22 of write strategy giving the parameters P1, P2, . . . , Pn as a information to the record carrier on beforehand and details of the recording device is determined. After the determination of an appropriate write strategy for the concrete record carrier and the concrete recording device the recording process represented as step S34 can be started.

It has to be mentioned that the steps represented in the above embodiment are not fixed. A skilled person may add some additional steps or remove some of the above described steps. For performing recording according to the present invention, the steps of reading the reference 2100 to a class 22 of write strategy and of performing write strategy optimization by use of the reference 2100 may as well be accompanied by other system specific steps or modified in line with the individual recording and reproducing systems. A suitable write strategy for the record carrier is thus sought by use of the reference 2100 as an additional information about said carrier on before-hand.

It is noted that the present record carrier and the present recording method are not restricted to the preferred embodiment described above but can be used for any record carrier of a recordable type. Thus, the preferred embodiment may vary within the scope of the attached claims.

1. A record carrier of a recordable type, said record carrier comprising at least one area in which record carrier related information is stored, wherein said record carrier related information comprises at least one reference to a class of write strategy, wherein said class of write strategy comprises parameters constituting a certain write strategy for the record carrier and is provided for use in write strategy optimization.

2. A record carrier according to claim 1, wherein said parameters constituting write strategy comprise at least one of the information about:
waveform format;
pulse repetition rate;
pulse-train length;
history-compensation depth;
future-compensation depth;
short-mark power boost; or
start and/of stop of mark power boost.

3. A method of recording information on a recordable record carrier, wherein said record carrier comprises at least one area in which record carrier related information is stored, wherein said record carrier related information comprises at least one reference to a class of write strategy, wherein said class of write strategy comprises parameters constituting a certain write strategy for the record carrier and is provided by use for write strategy optimization, and wherein the method comprises steps of:
reading of said reference to a class of write strategy;
performing write strategy optimization by use of said reference to a class of write strategy, wherein a suitable write strategy for said record carrier is sought by use of said reference to a class of write strategy as an additional information about said record carrier on beforehand.

4. A method according to claim 3, wherein said parameters constituting write strategy comprise at least one of the information about:
waveform format;
pulse repetition rate;
pulse-train length;
history-compensation depth;
future-compensation depth;
short-mark power boost; or
start and/of stop of mark power boost.

5. A recording device for recording information on a recordable record carrier, wherein said device is operative for executing the steps of method claim 3.

6. A method of manufacturing a record carrier according to one of claims 1 or 2, said method comprising the step of writing at least one said reference to a class of write strategy on at least one area of said record carrier.

7. A method according to claim 6, wherein said area of said record carrier is address in pre-groove (ADIP).

8. A method according to claim 6, wherein said area of said record carrier is absolute time in pre-groove (ATIP).

9. A method according to claim 6, wherein said reference to a class of write strategy is written in a look-up table located in the said area.
